(19) United States
(12) Patent Application Publication
(10) Pub. No.: US 2020/0206861 A1
(43) Pub. Date: Jul. 2, 2020

(54) METHOD FOR DETERMINING THE TOPOGRAPHY OF A MACHINE TOOL

(71) Applicant: SCHWABISCHE WERKZEUGMASCHINEN GMBH, Schramberg-Waldmossingen (DE)

(72) Inventor: Johannes BAUR, Dietingen (DE)

(73) Assignee: SCHWABISCHE WERKZEUGMASCHINEN GMBH, Schramberg-Waldmossingen (DE)

(21) Appl. No.: 16/716,623

(22) Filed: Dec. 17, 2019

(30) Foreign Application Priority Data
Dec. 27, 2018 (DE) 102018133628.4
Feb. 22, 2019 (DE) 102019104604.1

(51) Int. Cl. B23Q 17/00; B23Q 1/01

(52) U.S. Cl. CPC B23Q 17/003; B23Q 1/017

(57) ABSTRACT

A method for determining the topography of a machine tool that includes a machine bed, a tool carrier and a component carrier. The machine bed defines a Cartesian coordinate system of the machine tool starting from a machine zero point. The tool carrier can be moved along linear guides aligned in parallel to axes of the coordinate system and has at least one tool holder for holding a cutting tool. The component carrier is at a distance from the tool carrier in the direction of a first axis and can be at least almost completely pivoted around an axis of rotation aligned in parallel to a second axis, if necessary, and includes a component receptacle aligned in parallel to the first axis, through which a component to be machined can be held.

### CROSS REFERENCE TO RELATED APPLICATIONS

This application claims the benefit of DE 10 2018 133 628.4, filed Dec. 17, 2018, and DE 10 2019 104 604.1, filed Feb. 22, 2019, both of which are incorporated by reference.

The invention concerns a method by means of which a topography of a machine tool can be determined, in particular within the context of calibration of the machine tool.

### BACKGROUND OF THE INVENTION

Modern machine tools, in particular the so-called machining centres, combine high flexibility in machining processes with high machining accuracy. In order to achieve this high machining accuracy, it is necessary that a machine tool is measured as accurately as possible and calibrated on the basis of the data obtained before it is put into operation. In addition, it is also necessary to repeat this calibration at regular intervals and when necessary, for example after an unforeseen operating condition of the machine tool.

The calibration of the machine tool is essentially carried out manually by skilled personnel on the basis of measurement instructions and measurement protocols. A particular disadvantage here is that this type of calibration is time-consuming and that even highly qualified personnel can never completely prevent measurement values from being recorded and/or transmitted incorrectly or inaccurately.

### SUMMARY OF THE INVENTION

One of the tasks of an invention embodiment is to provide a method by which the determination of the topography is simplified and can be performed more accurately.

This task is solved according to the invention by a method for determining a topography of a machine tool that exhibits: a machine bed by means of which a cartesian coordinate system of the machine tool starting from a machine zero point is defined, a tool carrier which can be moved along linear guides which are aligned in parallel to axes of the coordinate system and which has at least one tool holder for receiving a cutting tool, and a component carrier, which is spaced from the tool carrier in the direction of a first axis and can optionally be pivoted at least almost completely around an axis of rotation aligned in parallel to a second axis and which comprises a component receptacle aligned in parallel to the first axis, it being possible for a component to be machined to be held by the component receptacle, which method comprises the steps:
(a) determining and capturing the orientation of the machine bed;
(b) determining and capturing of the straightness of the linear guides;
(c) determining and capturing the orientation of the component carrier in relation to the coordinate system;

at least the determination in steps b and/or c being carried out by means of at least one automated or automatable measuring device which is connected or can be connected to a data processing device in a way that data and/or signals can be transferred.

It is conceivable that the determination and capture according to step (a) is carried out manually or semi-automatically. The method can be further simplified if the determination and/or capture in step (a) is also carried out by means of the one, or another, automated or automatable measuring device which is connected or can be connected to the data processing device in a way that data and/or signals can be transferred.

The determination and capture referred to in step (a) may include in particular the determination and detection of an inclination of the machine bed by means of an inclinometer. The inclinometer can, for example, be placed on an alignment surface of the machine bed which, if the machine bed is correctly aligned, is aligned perpendicularly to the gravitational force acting at the location of the alignment surface.

In addition, to determine the straightness of the linear guides in step (b), a tool carrier tilt angle may be determined as it travels along the axes of the coordinate system. If the inclination angle of the tool carrier remains constant during the movement, the linear guides are straight. If the inclination angle of the tool carrier changes, the linear guides will have curved, especially warped, or angled sections.

In the case of an advantageous further evolution of the method, it is planned that the determination of the orientation of the component carrier in relation to the coordinate system of the machine tool is carried out in step (c) by means of a measuring device which can be positioned on the machine bed as a function of the coordinate system, for example by means of a laser distance meter.

In addition, it is appropriate that, in particular after one of the steps (a), (b) or (c), a further step is taken, namely:
(d) Determination and capture of the arrangement of the linear guides relative to one another by means of the one, or a further, automated or automatable measuring device which is connected or can be connected to the data processing device in a way that data and/or signals can be transferred.

Based on the data obtained in steps (a) to (c), step (d) makes it easy to determine whether the linear guides are perpendicular to each other. The advantage of this is that a measuring angle can be arranged on the component holder which can be felt by the probe held by the tool holder. The measuring angle has contact surfaces that can be aligned simultaneously parallel to three spatial planes drawn up by the first axis, the second axis and the third axis.

To determine a perpendicularity of the second axis to the third axis, it is advantageously provided that the measurement angle is aligned such that one of the probing surfaces is aligned in parallel to the spatial plane formed by the second and third axes. Then touch points are determined along a spatial line parallel to the third axis. Then touch points are determined along a space line aligned in parallel to the second axis. From the spatial lines determined by the probe and, in particular, from the data from a machine control system, it can be determined whether the linear guides associated to the second axis and the third axis are arranged at right angles to one another.

In order to determine the perpendicularity of the first axis to the second and third axes, it is advantageously provided that a scanning surface of the measuring angle is at least nearly aligned in parallel to the spatial plane drawn up by the first and second axes and by the first and third axes, respectively. Then touch points are determined along a space line aligned in parallel to the second or third axis. Then touch points are determined along the space line aligned in parallel to the first axis. From the space lines determinable by the measuring probe and in particular from the data of the machine control, it can be determined whether the linear guides associated to the first axis and the second or third axis, respectively, are arranged at least substantially at right angles to one another.

In addition, it proves to be advantageous if, in particular after one of the steps (a), (b), (c) and/or (d), a further step is carried out, namely:
(e) Determining and capturing an offset of the tool holder in the direction of the first axis and/or the third axis by means of the one, or a further, automated or automatable measuring device which is connected or can be connected to the data processing device in a way that data and/or signals can be transferred.

Based on the data obtained in steps (a) to (d), it is advantageous to determine in step (e) whether the tool holder has an offset in the direction of the first axis and/or the third axis.

For this purpose, it is provided that a sensing surface is or can be arranged on the component holder which can be aligned perpendicularly to the first or third axis and in parallel to the second axis. It is advantageous that several probe points spaced apart in the direction of the second axis and arranged on the probe surface are approached with the measuring probe. This makes it possible to determine the offset of the tool holder in the direction of the first or third axis.

In an evolution of the latter embodiment, it proves to be advantageous if, when determining the offset of the tool holder in the direction of the first or third axis, the straightness of the scanning surface is also checked in order, for example, to determine wear, damage or the like on the component holder and/or the component carrier. Here it is particularly advantageous if the scanning surface is formed as a section of the component holder.

Furthermore, in the case of an implementation form of the method, it is provided that after one of the steps (a), (b), (c), (d) and/or (e), a further step may be carried out, namely:
(f) Determining and capturing an offset of the tool holder in the direction of the second axis by means of the one, or a further, automated or automatable measuring device which is connected or can be connected to the data processing device in a way that data and/or signals can be transferred.

On the basis of the data determined in steps (a) to (e), it is advantageously possible to determine in step (f) whether the tool holder has an offset in the direction of the second axis. A recess with a known position and a known shape, e.g. a bore, is particularly preferred for this purpose.

It is advantageous to approach the recess with the probe in such a way that its position in the coordinate system is determined. The values determined for the positions of the recesses can be used to determine whether the tool holder has a deposit along the second axis.

In addition, it is appropriate to carry out a further step after steps (a), (b), (c), (d), (e) and/or (f), namely:
(g) Determining and capturing the concentricity of the tool holder and an angle difference between a tool axis and the first axis by means of the one, or a further, automated or automatable measuring device which is connected and/or connectable to the data processing device in a way that data and/or signals can be transferred.

This step of the process determines in particular whether a tool arranged in the tool holder rotates evenly around the tool axis and whether the angular difference between the tool axis and the first axis is within the specified tolerance. For this purpose, it is advantageously provided that a measuring mandrel is arranged in the tool holder, said measuring mandrel having a cylindrical probe surface arranged parallel to the first axis, and a measuring probe being arranged in the component holder.

In order to determine the concentricity of the tool holder, it is intended that the tool holder with the measuring mandrel arranged in it is rotated stepwise around the first axis, while after each rotation step, the measuring mandrel is scanned by means of the measuring probe arranged in the component holder. From the touch points determined in this way, a deposit of the measuring mandrel can be determined with respect to the ideal concentricity.

In order to determine the angle difference between the tool axis and the first axis, it is intended that the tool holder is moved stepwise along the first axis with the measuring mandrel arranged in it, while after each movement step, the measuring mandrel is scanned by means of the measuring probe arranged in the component holder. An angular difference between the tool axis and the first axis can be determined from the touch points determined in this way.

In addition, it is advantageous if after one of the steps (a), (b), (c), (d), (e), (f) and/or (g) a further step is carried out, namely:
(h) Determination and capture of an angle difference between the tool axis and the second axis and/or the tool axis and the third axis by means of the one, or a further, automated or automatable measuring device which is connected or connectable to the data processing device in a way that data and/or signals can be transferred.

In this step of the method, it is determined in particular whether the tool holder is arranged perpendiculary with respect to the second axis and the third axis. For this purpose, it is advantageously provided that a measuring tool which has a probe surface aligned in parallel to the second and third axis is arranged in the tool holder, a measuring probe being arranged in the component holder.

In order to determine the perpendicularity of the tool holder with respect to the second axis and the third axis, the tool holder is rotated stepwise around the first axis with the measuring tool arranged in it and positioned over the second and third axes, while after each rotation step probe point arranged on the probe surface is scanned with the probe. A circular path/arc can be determined from the data thus determined, along which the touch point moves and from which it can be determined whether the tool holder is arranged at right angles to the second and third axes.

Furthermore, in one embodiment of the method, it is provided that after one of the steps (a), (b), (c), (d), (e), (f), (g) and/or (h), a further step is carried out, namely:
(i) Determining and capturing an angle difference between a carrier rotation axis of the component carrier and the first axis and/or the carrier rotation axis and the third axis by means of the one, or a further, automated or automatable measuring device which is connected or connectable to the data processing device in a way that data and/or signals can be transferred.

In this step, the alignment of the component carrier is checked on the basis of the data determined in previous steps, preferably automatically. For this purpose, for example, a measuring probe can be arranged in the tool holder, wherein a kinematic measuring device, which in particular has a spherical probe body, is arranged on a first rotational section of the component carrier by which the component holder is held and which is rotatable around the axis of rotation of the carrier.

The first portion of rotation of the component carrier is rotated stepwise around the axis of rotation of the carrier, wherein after each step of rotation the component carrier is moved along the corresponding linear axes in such a way that the probe is directed in the direction of a perpendicular line with respect to the surface of the probe body running through the probe point when scanning the probe body. A circular path/arc can be determined from the data thus determined, along which the touch point moves and from which an angular difference between the axis of rotation of the carrier and the first and/or second axis can be determined.

It may also be provided that the method may be applied to a machine tool whose component carrier has a second rotation section opposite to the first rotation section. In such a machine tool, the component holder is held, guided and driven by both rotation sections.

In a further embodiment of the method, it is provided that after step (i), the step:
(j1) Determination and detection of a parallelism of the component carrier in relation to the second axis and/or the third axis by means of the one, or a further, automated or automatable measuring device which is connected or connectable to the data processing device in a way that data and/or signals can be transferred,

and that the machine tool comprises a 3-axis machine tool, to the component holder of which a component can be fixed in a torsion-proof manner.

In step (j1) it is intended that the parallelism of the component fixture to the second axis and to the third axis is checked. For this purpose, it is intended that a measuring probe is arranged in the tool holder, with which flat surfaces of the component holder are scanned that can be aligned in parallel to the second and/or third axis. This makes it possible to determine whether the component fixture can actually be aligned in parallel to these axes.

In addition, one of the embodiments of the method provides that the machine tool comprises a 4-axis machine tool, to the component holder of which a component can be fixed in a torsion-proof manner, and that after step (i), the steps:
(j2) Determining and capturing the kinematics of the first axis of rotation of the component carrier during its rotation around the axis of rotation of the carrier by means of the one, or a further, automated or automatable measuring device which is connected or connectable to the data processing device in a way that data and/or signals can be transferred, and
(k1) Determination and detection of a parallelism of the component carrier in relation to the second axis and/or the third axis by means of the one, or a further, automated or automatable measuring device which is connected or connectable to the data processing device in a way that data and/or signals can be transferred,

are carried out.

Kinematics of the first axis of rotation is understood in the following as rotations of elements of the machine tool about the auxiliary axes related to the component carrier, which correspond to the axis of rotation of the carrier and the auxiliary axis parallel to it.

In step (j2) it is intended that the position of the rotation axis is checked and whether—or not—the carrier rotation axis is actually perpendicular to the corresponding linear axes. In addition, step (j2) checks whether the auxiliary axis parallel to the carrier rotation axis is perpendicular to the corresponding linear axes.

In order to check the position and perpendicularity of the carrier rotation axis, it is advantageously provided that the kinematic measuring device is fixed to the component holder, while a measuring probe is arranged in the tool holder. The component carrier is rotated stepwise around the carrier rotation axis, while after each rotation step the component carrier is moved along the corresponding linear axes in such a way that the probe is directed in the direction of a perpendicular line with respect to the surface of the probe body running through a probe point when scanning the probe body. From the data determined in this way, a circular path/arc can be determined along which the touch point moves.

The perpendicularity of the carrier rotation axis with respect to the corresponding linear axes can be determined from an angular position between the plane drawn up by the circular path/arc and a plane drawn up by a center of the circular path/arc and the corresponding linear axes.

In order to check the alignment of the auxiliary axis parallel to the carrier rotation axis, it is advantageous that the kinematic measuring device is fixed to the component fixture with a probe arranged in the tool fixture. The component carrier is moved stepwise along the axis of rotation of the carrier, with the component carrier being moved along the corresponding linear axes after each traversing step in such a way that the probe, when scanning the probe body, is directed in the direction of a perpendicular line with respect to the surface of the probe body running through a probing point. Based on the known machine parameters, a space line can be determined along which the touch probe will be moved. A perpendicularity of the auxiliary axis parallel to the carrier rotation axis to the corresponding linear axes can be determined from an angular position between the determined space line and a perpendicular of the plane drawn up by the corresponding linear axes.

In step (k1) it is intended that a parallelism of the component fixture to the first, second and third axis is checked. For this purpose, it is provided that a measuring probe is arranged in the tool holder, with which flat surfaces of the component holder, which can be aligned in parallel to the first and/or second and/or third axis, are scanned. This makes it possible to determine whether the component fixture can actually be aligned in parallel to these axes.

It is advantageous that the component carrier with the component fixture is rotated 360° in a first direction around the axis of rotation of the carrier for a first check of the parallelism of the component fixture. The component carrier is then rotated 360° in a second direction around the axis of rotation of the carrier and a second parallelism check is carried out. This makes it possible to detect reversal errors when rotating around the carrier rotational axis.

Furthermore, in an embodiment of the method, it is provided that the machine tool comprises a 5-axis machine tool, the component holder of which comprises a rotary section which is rotatable around a component axis, and that after step (i), the steps:
(j3) Determination and capture of the kinematics of the first axis of rotation of the component carrier during its rotation around the axis of rotation of the carrier by means of the one, or a further, automated or automatable measuring device, which is connected or connectable to the data processing device in a way that data and/or signals can be transferred,
k2. Determination and capture of the kinematics of the second axis of rotation of the rotary section of the component holder during its rotation around a component axis of rotation by means of the one, or a further, automated or automatable measuring device which is connected or connectable to the data processing device in a way that data and/or signals can be transferred,
(l) determining and capturing the flatness of the rotary section of the component mounting by means of the one, or a further, automated or automatable measuring device, which is connected or can be connected to the data processing device in a way that data and/or signals can be transferred, and
(m) determination and capture of the concentricity of the rotary section of the component holder in relation to the tool holder by means of the one, or a further, automated or automatable measuring device which is connected or connectable to the data processing device in a way that data and/or signals can be transferred

are carried out.

In step (j3), similar to step (j2), it is intended to check the position of the carrier rotation axis and whether the carrier rotation axis is actually perpendicular to the corresponding linear axes. Furthermore, in step (j3), in analogy to step (j2), the check is performed whether the auxiliary axis parallel to the carrier rotation axis is aligned perpendicularly to the corresponding linear axes.

In order to check the position and perpendicularity of the carrier rotation axis, the kinematic measuring device is fixed to the rotary section of the component fixture in deviation from step (j2), while the probe is arranged in the tool fixture. Furthermore, the position and perpendicularity of the carrier rotation axis with respect to the corresponding linear axes is determined analogously to step (j2).

In order to check the alignment of the auxiliary axis parallel to the axis of rotation of the carrier, it is advantageous in the case of the 5-axis machine tool that the kinematic measuring device, unlike in the case of the 4-axis machine tool, is fixed to the rotary section of the component holder, a probe being arranged in the tool holder. The determination of the position of the auxiliary axis parallel to the axis of rotation of the carrier and the perpendicularity between the auxiliary axis parallel to the axis of rotation of the carrier and the corresponding linear axes is carried out further in analogy to the method used in the 4-axis machine tool and described in step (j2).

The kinematics of the second axis of rotation is referred to and understood below as a rotation of elements of the machine tool around the auxiliary axes related to the rotary section of the component carrier, which correspond to the component axis of rotation of the rotary section and the auxiliary axis parallel to it.

In step (k2), the position of the component rotation axis is checked and whether the component rotation axis is perpendicular to the corresponding linear axes. In addition, in step (k2) the position of the auxiliary axis parallel to the component rotation axis is checked and whether this auxiliary axis is aligned perpendicular to the corresponding linear axes.

In order to check the perpendicularity of the component rotation axis, it is advantageously provided that the kinematic measuring device is fixed to the rotary section of the component holder, while a measuring probe is arranged in the tool holder. The rotating section is rotated stepwise around the axis of rotation of the component, while after each rotation step the component carrier is moved in such a way that the probe is directed in the direction of a perpendicular line with respect to the surface of the probe body running through a probe point when scanning the probe body. From the data determined in this way, a circular path/arc can be determined along which the touch point moves.

The perpendicularity of the carrier rotation axis with respect to the corresponding linear axes can be determined from an angular position between the plane drawn up by the circular path/arc and a plane drawn up by a center of the circular path/arc and the corresponding linear axes.

In order to check the alignment of the auxiliary axis parallel to the component rotation axis, it is advantageous that the kinematic measuring device is fixed to the rotary section of the component fixture with a probe arranged in the tool fixture. The component carrier is moved stepwise along the axis of rotation of the component, the rotary section always having the same angle of rotation relative to the component holder, and the component carrier or tool carrier being moved after each traversing step in such a way that the probe, when scanning the probe body, is directed in the direction of a perpendicular line with respect to the surface of the probe body running through a probing point. Based on the known machine parameters, a distance can be determined along which the touch probe body is moved. The perpendicularity of the auxiliary axis parallel to the component rotation axis to the corresponding linear axes can be determined from an angular deviation between the determined distance and a perpendicular of the plane drawn up by the corresponding linear axes.

It is advantageous that in step (l), touch points are detected stepwise on the rotary section by means of a probe arranged in the tool holder. After a first pass, the rotary section is rotated by 180° around the axis of rotation of the component and measured again in a second pass. A circular path along which the touch point moves can be determined from the data determined in this way. The circular path of the touch point of the rotating section is preferably determined at three positions of the component carrier: at a 0° position where the axis of rotation of the component is parallel to the first axis and perpendicular to the second and third axes, and at a 90° position and at a −90° position. Measurements are also particularly preferred in the positions after the positions of the component carrier have been tuned to from different directions of travel.

The circular paths determined in step (l) can be used to determine the flatness of the rotating section, a skewness of the component rotation axis, the position of the carrier rotation axis and its reversal error.

In order to determine the concentricity of the rotary section of the component holder in relation to the tool holder in step (m), it is advantageously provided that at least a first and a second measuring recess are approached by means of a measuring probe arranged in the tool holder. The first measuring recess is preferably a centring hole of the rotating section through which the axis of rotation of the component runs, and the second measuring recess is a fixture mounting hole for aligning a fixture on the rotating section.

In order to determine the reversal error when rotating the rotating section around the axis of rotation of the component, it is advantageous that the measuring recesses are approached twice, namely respectively after the rotating section has been rotated by 360° in opposite directions.

In one embodiment of the method, it is provided that a topography protocol of the machine tool is generated by the data processing device on the basis of the data determined and captured in steps (a) to (i) and (j 1) or (a) to (i) and (j2) to (k1) or (a) to (i) and (j3) to (m). Based on the topography protocol, the machine tool can be calibrated, for example.

It is also possible to create topography logs as part of regular maintenance work, which can be compared with each other, for example, in order to detect changes in the machine tool.

It is also advantageous that partial topography protocols can be created that only consider part of steps a to (i) and (j1) or (a) to (i) and (j2) to (k1), or (a) to (i) and (j3) to (m).

Furthermore, in an embodiment of the method, it is provided that the data processing device determines correction values on the basis of at least one rule stored in the data processing device, by means of which correction values can be adjusted according to the topography of the machine tool. The accuracy of the machine tool can be improved by adjusting the machine tool on the basis of the correction values.

It is further provided in an embodiment of the method that the data processing device and/or a further data processing device produces an acceptance protocol of the machine tool on the basis of the topography protocol and/or the correction values. When the machine tool is initially commissioned, it is common that important parameters of the machine tool are recorded. For example, it is common that settings made to calibrate the machine tool are documented.

In a further embodiment of the method, it is intended that the topography of the machine tool be mechanically adjusted on the basis of the topography protocol and/or the correction values. Mechanical adjustment in the sense of the inventive idea means both the adjustment of the machine by means of adjustment elements provided for this purpose and the reworking of the machine, for example by means of cold forming with chisels, hammers, hydraulic presses or similar.

Furthermore, in an embodiment of the method, it is provided that the topography protocol and/or the correction values are transmitted from the data processing means to a control means of the machine tool which performs a control of the machine tool on the basis of the topography protocol and/or the correction values.

Further features, details and advantages of the invention result from the disclosure, from the graphic representation and subsequent description of preferred embodiments of the method.

### BRIEF DESCRIPTION OF THE DRAWINGS

The drawings show the following:

FIG. 1 A schematic flowchart of a first embodiment of the method;

FIG. 2 A schematic flowchart of a second embodiment of the method;

FIG. 3 A schematic flowchart of a third embodiment of the method.

### DETAILED DESCRIPTION OF THE INVENTION

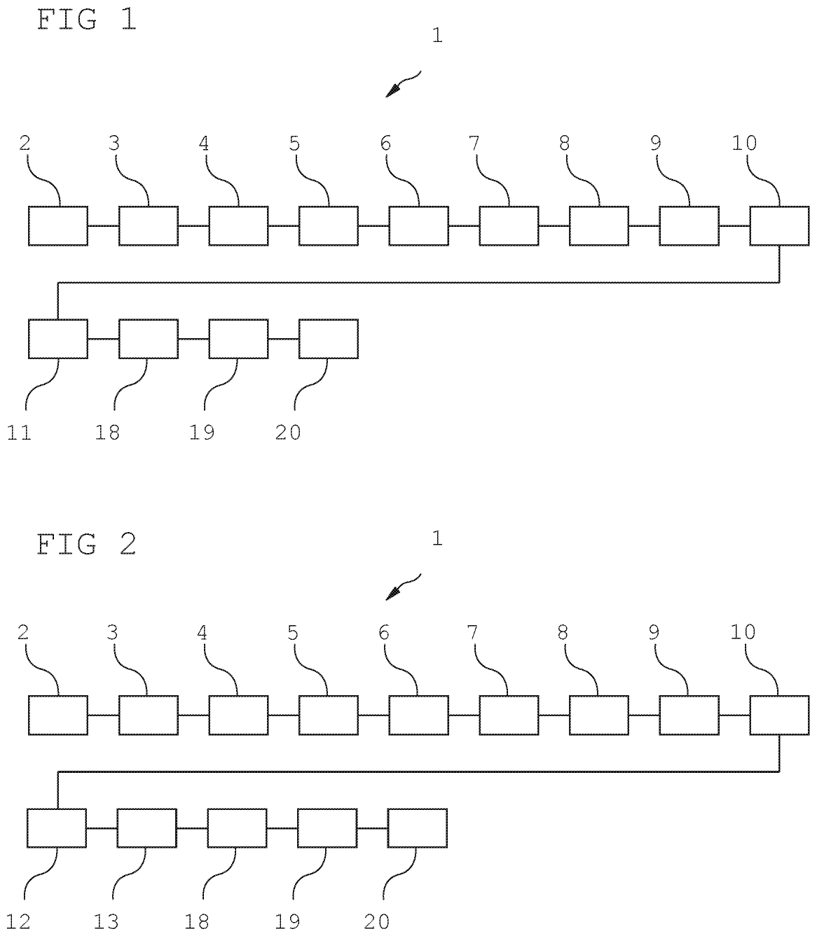

FIG. 1 shows a method 1 for determining the topography of a machine tool. The machine tool has a machine bed by which a cartesian coordinate system of the machine tool starting from a machine zero point is defined, a tool carrier which is moveable along linear guides which are aligned in parallel to axes of the coordinate system and which comprises at least one tool receptacle for receiving a cutting tool and a component carrier which is spaced apart from the tool carrier in the direction of a first axis and which comprises a component receptacle which is aligned in parallel to the first axis and by which a component to be machined can be held.

In step (a) 2 of method 1, the alignment of the machine bed is determined and recorded. The straightness of the linear guides is then determined and recorded in step (b) 3, e.g., using lasers or position sensors or optical sensors. In step (c) 4, the alignment of the component carrier in relation to the coordinate system is then determined and recorded. In method 1 described, the determination in steps (b) 3 and (c) 4 is carried out by means of automated measuring devices which are connected to a data processing device in a way that data and/or signals can be transferred, where the data processing device at least includes hardware and software and a processor to carry out the processing.

After steps (a) 2, (b) 3 and (c) 4, step (d) 5 is carried out where the arrangement of the linear guides relative to one another is determined and captured by means of an automated measuring device, e.g., lasers or sensors or optical sensors, which is connected to the data processing device in a way that data and/or signals can be transferred.

After steps (a) 2, (b) 3, (c) 4 and (d) 5, step (e) 6 is carried out where an offset of the tool holder in the direction of the first axis and the third axis is determined and captured by means of an automated measuring device which is connected to the data processing device in a way that data and/or signals can be transferred.

After steps (a) 2, (b) 3, (c) 4, (d) 5 and (e) 6, step (f) 7 is carried out where an offset of the tool holder in the direction of the second axis is determined and detected by means of an automated measuring device which is connected to the data processing device in a data-conducting manner.

After steps (a) 2, (b) 3, (c) 4, (d) 5, (e) 6 and (f) 7, step (g) 8 is carried out where an angular difference between a tool axis and the first axis and the concentricity of the tool holder is determined and captured by means of an automated measuring device which is connected to the data processing device in a data-conducting manner.

After steps (a) 2, (b) 3, (c) 4, (d) 5, (e) 6, (f) 7 and (g) 8, step (h) 9 is carried out where an angular difference between the tool axis and the second axis and between the tool axis and the third axis is determined and captured by means of an automated measuring device which is connected to the data processing device in a data-conducting manner.

After steps (a) 2, (b) 3, (c) 4, (d) 5, (e) 6, (f) 7, (g) 8 and (h) 9, step (i) 10 is carried out where an angular difference between a carrier rotation axis of the component carrier and the first axis as well as the carrier rotation axis and the third axis is determined and captured by means of an automated measuring device which is connected to the data processing device in a data-conducting manner.

After steps (a) 2, (b) 3, (c) 4, (d) 5, (e) 6, (f) 7, (g) 8, (h) 9 and (i) 10, step (j1) 11 is carried out in the embodiment of method 1 shown in FIG. 1. In step (j1), the parallelism of the component carrier in relation to the second axis and/or the third axis is determined and detected by means of an automated measuring device which is connected to the data processing device in a data-conducting manner.

The method 1 shown is preferably used with a 3-axis machine tool, where a component can be attached to the component holder in a torsion-proof manner.

After steps (a) 2, (b) 3, (c) 4, (d) 5, (e) 6, (f) 7, (g) 8, (h) 9 and (i) 10, steps (j2) 12 and (k1) 13 are carried out differently from the embodiment of method 1 shown in FIG. 2 than for the embodiment shown in FIG. 1. In step (j2) 12, the kinematics of the first axis of rotation of the component carrier during its rotation around the axis of rotation of the carrier is determined and captured by means of an automated measuring device which is connected to the data processing device in a data-conducting manner Subsequently, in step (k1) 13, the parallelism of the component carrier in relation to the first axis and/or the second axis and/or the third axis is determined and detected by means of an automated measuring device which is connected to the data processing device in a data-conducting manner.

The method 1 shown in FIG. 2 is preferably used on a 4-axis machine tool, where a component can be fixed to the component holder in a torsion-proof manner.

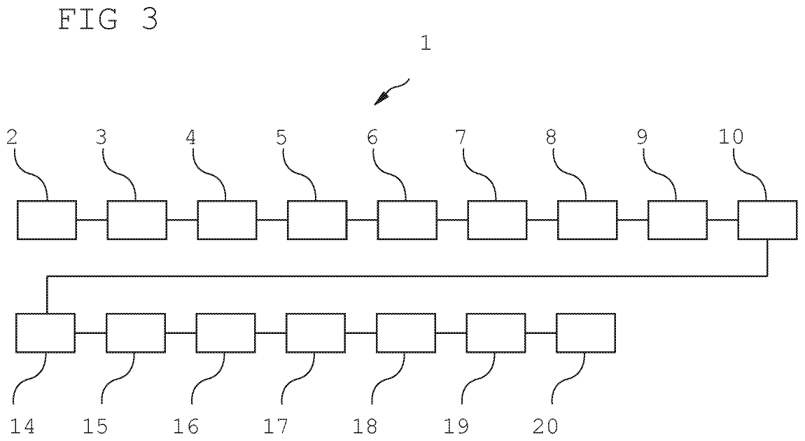

In contrast to the embodiment shown in FIG. 2, steps (j3) 14, (k2) 15, (l) 16 and (m) 17 are performed after the steps (a) 2, (b) 3, (c) 4, (d) 5, (e) 6, (f) 7, (g) 8, (h) 9 and (i) 10 in the embodiment of the method shown in FIG. 3. This embodiment of method 1 is preferably used on a 5-axis machine tool, the component holder of which comprises a rotary section that can be rotated around a component axis.

In step (j3) 14, kinematics of the first axis of rotation of the component carrier during its rotation around the axis of rotation of the carrier is determined and captured by means of an automated measuring device which is connected to the data processing device in a data-conducting manner Subsequently, in step (k2) 15, a kinematics of the second axis of rotation of the rotary section of the component holder is determined and captured during its rotation around the axis of rotation of the component by means of an automated measuring device which is connected to the data processing device in a data-conducting manner. Then, in step (l) 16, the flatness of the rotary section of the component fixture is determined and captured by means of an automated measuring device which is connected to the data processing device in a data-conducting manner. Then, in step (m) 17, the concentricity of the rotary section of the component holder in relation to the tool holder is determined and captured by means of an automated measuring device which is connected to the data processing device in a data-conducting manner.

Both in the method 1 shown in FIG. 1, and in the method 1 shown in FIG. 2 and FIG. 3, step (j1) 11 or step (k1) 13 or step (m) 17 is followed, on the basis of the data determined and recorded in the respective preceding steps, by a topography creation step 18, in which a topography protocol of the machine tool is created.

In method 1 shown in FIGS. 1 to 3, both after each individual determination step and after the entire topography creation step 18, a correction determination step 19 is performed by the data processing device on the basis of the topography protocol and rules stored in the data processing device, in which correction values are determined that allow the topography of the machine tool to be adjusted. The adjustment takes place either mechanically or by means of control technology, e.g., control systems including hardware and/or software.

In method 1 shown in FIGS. 1 to 3, after topography creation step 18 and correction determination step 19, a final protocol step 20 is performed by the data processing device on the basis of the topography protocol, in which an acceptance protocol of the machine tool is created.

The features of the invention revealed in the above description, claims and drawing may be essential both individually and in any combination in the realization of the invention in its various embodiments.

1. A method for determining a topography of a machine tool, comprising:
a machine bed that defines a Cartesian coordinate system of the machine tool starting from a machine zero point,
a tool carrier which is moveable along linear guides which are aligned in parallel to axes of the coordinate system and which has at least one tool receptacle for receiving a cutting tool, and
a component carrier which is spaced from the tool carrier in the direction of a first axis and which can optionally be at least completely pivoted around an axis of rotation aligned in parallel to a second axis and which comprises a component receptacle aligned in parallel to the first axis by means of which a component to be machined can be held,
the method comprising the steps:
a (2). determining and capturing an orientation of the machine bed;
b (3). determining and capturing a straightness of the linear guides,
c (4). determining and capturing an orientation of the component carrier in relation to the coordinate system;
wherein at least the determination in steps (b) (3) and/or (c) (4) is carried out by means of at least one automated or automatable measuring device which is connected or connectable to a data processing device in a way that data and/or signals is transferred.

2. The method according to claim 1, wherein a further step is carried out after one of the steps (a) (2), (b) (3) or (c) (4), wherein the further step comprises:
(d) (5) determining and capturing the arrangement of the linear guides relative to one another by means of the one, or a further, automated or automatable measuring device which is connected or connectable to the data processing device in a way that data and/or signals is transferred.

3. The method according to claim 2, wherein one of the steps (a) (2), (b) (3), (c) (4) and/or (d) (5) is followed by a further step, wherein the further step comprises:
(e) (6) determining and capturing an offset of the tool holder in the direction of the first axis and/or the third axis by means of the one, or a further, automated or automatable measuring device which is connected or connectable to the data processing device in a way that data and/or signals is transferred.

4. The method according to claim 3, wherein one of the steps (a) (2), (b) (3), (c) (4), (d) (5) and/or (e) (6) is followed by a further step, wherein the further step comprises:
(f) (7) determining and capturing an offset of the tool holder in the direction of the second axis by means of the one, or a further, automated or automatable measuring device which is connected or connectable to the data processing device in a way that data and/or signals is transferred.

5. The method according to claim 4, wherein one of the steps (a) (2), (b) (3), (c) (4), (d) (5), (e) (6) and/or (f) (7) is followed by a further step, wherein the further step comprises:
(g) (8) determining and capturing an angle difference between a tool axis and the first axis and the concentricity of the tool holder by means of the or a wide automated or automatable measuring device which is connected and/or connectable to the data processing device in a way that data and/or signals is transferred.

6. The method according to claim 5, wherein a further step is performed after one of the steps (a) (2), (b) (3), (c) (4), (d) (5), (e) (6), (f) (7) and/or (g) (8), wherein the further step comprises:
(h) (9) determining and capturing of an angle difference between the tool axis and the second axis and/or the tool axis and the third axis by means of the one, or a further, automated or automatable measuring device which is connected or connectable to the data processing device in a way that data and/or signals is transferred.

7. The method according to claim 6, wherein a further step is performed after one of the steps (a) (2), (b) (3), (c) (4), (d) (5), (e) (6), (f) (7), (g) (8) and/or (h) (9), wherein the further step comprises:
(i) (10) determining and capturing an angle difference between a carrier rotation axis of the component carrier and the first axis and/or the carrier rotation axis and the third axis by means of the one, or a further, automated or automatable measuring device which is connected or connectable to the data processing device in a way that data and/or signals is transferred.

8. The method according to claim 7, wherein after step (i) (10), the steps further comprise:
(j1) (11) determining and capturing of the parallelism of the component carrier in relation to the second axis and/or the third axis by means of the one, or a further, automated or automatable measuring device which is connected or connectable to the data processing device in a way that data and/or signals is transferred,
and that the machine tool comprises a 3-axis machine tool, to the component holder of which a component is able to fixed in a torsion-proof manner.

9. The method according to claim 7, wherein after step (i) (10), the steps further comprise:
(j2) (12) determining and capturing of the kinematics of the first axis of rotation of the component carrier during its rotation around the axis of rotation of the carrier by means of the one, or a further, automated or automatable measuring device, which is connected or connectable to the data processing device in a way that data and/or signals is transferred, and
(k1) (13) determining and capturing of the parallelism of the component carrier in relation to the first axis and/or the second axis and/or the third axis by means of the one, or a further, automated or automatable measuring device which is connected or connectable to the data processing device in a way that data and/or signals is transferred,
and that the machine tool comprises a 4-axis machine tool, to whose component holder a component is able to fixed in a torsion-proof manner.

10. The method according to claim 7, wherein after step i (10), the steps further comprise:
(j3) (14) determining and capturing of the kinematics of the first axis of rotation of the component carrier during its rotation around the axis of rotation of the carrier by means of the one, or a further, automated or automatable measuring device, which is connected or connectable to the data processing device in a way that data and/or signals is transferred,
(k2) (15) determining and capturing of the kinematics of the second axis of rotation of the component holder during its rotation around an axis of rotation of the component by means of the one, or a further, automated or automatable measuring device, which is connected or connectable to the data processing device in a way that data and/or signals is transferred,
(l) (16) determining and capturing the flatness of the component mounting of the one, or a further, automated or automatable measuring device, which is connected or is connectable to the data processing device in a way that data and/or signals is transferred, and
(m) (17) determining and capturing of the concentricity of the component holder in relation to the tool holder by means of the one, or a further, automated or automatable measuring device which is connected or is connectable to the data processing device in a way that data and/or signals is transferred,
and that the machine tool is a 5-axis machine tool, the component holder of which comprises a rotary section which is rotatable around a component axis.

11. The method according to claim 10, wherein a topography protocol of the machine tool is generated by the data processing device on the basis of the data determined and acquired in steps (a) (2) to (i) (10) and (j1) (11) or (a) (2) to (i) (10) and (j2) (12) to (k1) (13) or (a) (2) to (i) (10) and (j3) (14) to (m) (17).

12. The method according to claim 11, wherein the data processing device determines correction values on the basis of at least one rule stored in the data processing device, by means of which correction values the topography of the machine tool is adjusted.

13. The method according to claim 12, wherein the data processing device and/or a further data processing device produces an acceptance report of the machine tool on the basis of the topography protocol and/or the correction values.

14. The method according to claim 12, wherein the topography of the machine tool is mechanically adjusted on the basis of the topography protocol and/or the correction values.

15. The method according to claim 12, wherein the topography protocol and/or the correction values are transmitted from the data processing device to a control device of the machine tool which performs a control of the machine tool on the basis of the topography protocol and/or the correction values.
